(19) United States
(12) Patent Application Publication
(10) Pub. No.: US 2010/0031243 A1
(43) Pub. Date: Feb. 4, 2010

(54) METHOD FOR UPDATING SOFTWARE OF AN ELECTRONIC DEVICE, IN PARTICULAR OF THE RELEASE OF LOW-VOLTAGE CIRCUIT BREAKERS

(76) Inventor: Ilka Jakubowski, Falkensee (DE)

Correspondence Address: HARNESS, DICKEY & PIERCE, P.L.C., P.O.BOX 8910, RESTON, VA, 20195, US

(21) Appl. No.: 12/448,066

(22) PCT Filed: Nov. 29, 2007
(86) PCT No.: PCT/EP2007/063008

§ 371 Date: Jun. 5, 2009

(30) Foreign Application Priority Data
Dec. 8, 2006 (DE) 10 2006 059 107.0

(51) Int. Cl. G06F 9/44; G06F 12/00

(52) U.S. Cl. 717/168; 711/103; 711/E12.001

(57) ABSTRACT

A method is disclosed for updating software of an electronic device, in particular of the release of low-voltage circuit breakers, whose software is stored in a nonvolatile storage area. In at least one embodiment of the method, the updated software is copied from an external carrier into this storage area. In order to ensure safe operation of the circuit breaker even after a software update, at least one embodiment of the invention proposes that the updated software which has been copied to this storage area is checked by way of an external test device, that the test device, in the event of updated software which has been copied without any faults, writes a fault-free identification to the/a nonvolatile storage area, and that the updated software is only started by the electronic device if the fault-free identification for the updated software is present.

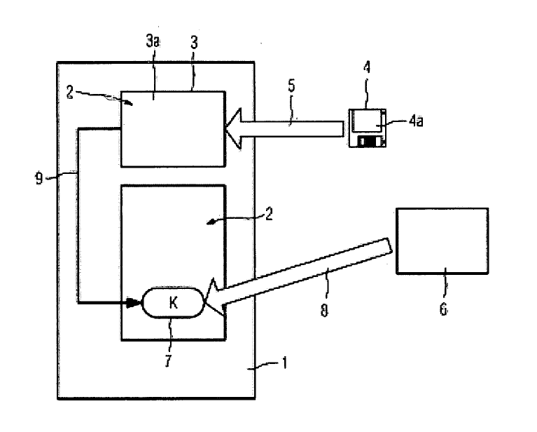

### PRIORITY STATEMENT

This application is the national phase under 35 U.S.C. §371 of PCT International Application No. PCT/EP2007/063008 which has an International filing date of Nov. 29, 2007, which designated the United States of America and which claims priority on German application No. 10 2006 059 107.0 filed Dec. 8, 2006, the entire contents of which are hereby incorporated herein by reference.

### FIELD

At least one embodiment of the invention generally relates to a method for updating the software of an electronic device, particularly the release in low-voltage circuit breakers.

### BACKGROUND

Today, releases in low-voltage circuit breakers require a piece of software which is called firm ware and which is tailored to the circuit breaker and controls the operation thereof. Error corrections and expansions of function mean that the firm ware is continually under further development and alteration. It is frequently necessary to safely install the updated firmware on the safety-related electronic releases. This should also be done by the customer himself where possible.

To ensure reliable operation, it is necessary to check at least the safety-relevant functions of the circuit breaker after the update. This check is usually performed using external testers; it can also be executed as internal functions, however.

A problem in this context is that the updated firmware itself cannot tell whether this check has actually been performed and has been performed successfully so as to ensure safe operation of the circuit breaker.

### SUMMARY

At least one embodiment of the invention is directed to ensuring safe operation of the circuit breaker even after a software update.

The solution, in at least one embodiment, provides for the updated software copied to this memory area to be checked by way of an external checking device, for the checking device to write an error-free identifier to the/a nonvolatile memory area when the updated software is copied without error, and for the updated software to be started by the electronic device only if the error-free identifier for updated software is present. This ensures that the (prescribed) check on the electronic device is also really performed after a software update. This makes a software update much safer and more reliable for safety-related devices too. In particular, an update of this kind can also be performed by the customer himself without special knowledge and training. This is a possibility since the majority of electronic releases in low-voltage circuit breakers are equipped with nonvolatile memories (EEPROM, FLASH and buffered RAM). In at least one embodiment of the invention, a portion of this memory is used to recognize the successfully performed check on the device by an external checking device.

Advantageously, the electronic device can also check the error-free identifier cyclically.

Safety can be increased if the memory area is overwritten with the error-free identifier by the updated software during copying or if the memory area is overwritten with a prescribed value for the purpose of storing the error-free identifier at the beginning of the software update.

### BRIEF DESCRIPTION OF THE DRAWINGS

At least one embodiment of the invention is described in more detail below with reference to a drawing with a single FIGURE.

The single FIGURE shows a schematic illustration of a release 1 in a low-voltage circuit breaker (not shown itself).

### DETAILED DESCRIPTION OF THE EXAMPLE EMBODIMENTS

The single FIGURE shows a schematic illustration of a release 1 in a low-voltage circuit breaker (not shown itself). The release has a nonvolatile memory 2, 3, the nonvolatile memory 3 being the firmware memory 3, that is to say the memory area which stores the operating software (firmware) 3a to be updated. In addition, the figure shows an external storage medium 4 (e.g. a floppy disk) which stores an up-to-date piece of firmware 4a. Upon request or automatically after the external storage medium 4 is connected, the updated software 4a is transferred from the external storage medium 4 to the firmware memory 3, as shown schematically by the arrow 5.

When the up-to-date firmware 4a has been transferred to the firmware memory 3 completely, said firmware memory being overwritten in the process, an external checking device 6 is connected to the release 1 and checks whether the updated firmware 3a has been stored in the firmware memory 3 correctly and without error. The check by the external checking device 6 is shown schematically in the figure by an arrow 8. If this is consistent, that is to say that the firmware 3a has been updated without error, an error-free identifier K is written to the nonvolatile memory 2, in which an identifier store 7 is reserved for this purpose only.

The error-free identifier K is overwritten with an up-to-date error-free identifier K, which has the current date, for example, in the identifier store 7 when freedom from error has been established.

Alternatively, it is possible for the identifier store 7 to be overwritten, at the beginning of the software update, with a prescribed nonidentifier value L first of all and with the error-free identifier K only after the firmware update has ended.

Before the updated firmware 3a is restarted, the error-free identifier K is respectively tested in the identifier store 7, as illustrated by the arrow 9.

It goes without saying that the test on the error-free identifier K can also take place cyclically.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for updating software of an electronic device, comprising:
storing software in a nonvolatile memory area;
copying updated software to the nonvolatile memory area from an external medium, the copied updated software being checked by an external checking device, the external checking device writing an error-free identifier to the nonvolatile memory area when the updated software is copied without error; and
starting the updated software on the electronic device, only if the error-free identifier for the updated software is present in the nonvolatile memory area.

2. The method as claimed in claim 1, wherein the electronic device checks the error-free identifier cyclically.

3. The method as claimed in claim 1, wherein the nonvolatile memory area is overwritten with the error-free identifier by the updated software during copying.

4. The method as claimed in claim 1, wherein the nonvolatile memory area is overwritten with a prescribed value for the purpose of storing the error-free identifier at the beginning of the software update.

5. The method of claim 1, wherein the method is for updating a release in a low-voltage circuit.

6. The method as claimed in claim 2, wherein the nonvolatile memory area is overwritten with the error-free identifier by the updated software during copying.

7. The method as claimed in claim 2, wherein the nonvolatile memory area is overwritten with a prescribed value for the purpose of storing the error-free identifier at the beginning of the software update.

8. The method as claimed in claim 3, wherein the nonvolatile memory area is overwritten with a prescribed value for the purpose of storing the error-free identifier at the beginning of the software update.

9. A method for updating software of an electronic device, comprising:
storing software in a nonvolatile memory area;
updating the stored software from an external medium, the updating being checked by an external checking device;
storing an error-free identifier, received from the external checking device, in the nonvolatile memory area when the software is updated without error; and
running the updated software on the electronic device, only if the error-free identifier for the updated software is stored in the nonvolatile memory area.

10. The method as claimed in claim 9, wherein the electronic device checks the error-free identifier cyclically.

11. The method as claimed in claim 9, wherein the nonvolatile memory area is overwritten with the error-free identifier during the updating.

12. The method as claimed in claim 9, wherein the nonvolatile memory area is overwritten with a prescribed value for the purpose of storing the error-free identifier at the beginning of the software update.

13. The method of claim 9, wherein the method is for updating a release in a low-voltage circuit.

14. The method as claimed in claim 10, wherein the nonvolatile memory area is overwritten with the error-free identifier during the updating.

15. The method as claimed in claim 10, wherein the nonvolatile memory area is overwritten with a prescribed value for the purpose of storing the error-free identifier at the beginning of the software update.

16. The method as claimed in claim 11, wherein the nonvolatile memory area is overwritten with a prescribed value for the purpose of storing the error-free identifier at the beginning of the software update.
